(19) United States
(12) Patent Application Publication
(10) Pub. No.: US 2008/0055828 A1
(43) Pub. Date: Mar. 6, 2008

(54) PORTABLE COMPUTER

(75) Inventor: Tzu-Ming Yang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ASUSTeK COMPUTER INC., Taipei (TW)

(21) Appl. No.: 11/849,302

(22) Filed: Sep. 3, 2007

(30) Foreign Application Priority Data
Sep. 1, 2006 (TW) 95132313

(51) Int. Cl. G06F 1/16; A47B 81/00

(52) U.S. Cl. 361/680; 312/223.2; 361/683

(57) ABSTRACT

A portable computer includes a plurality of electronic components and a case. The case includes a body shell portion suitable for accommodating the electronic components. The body shell portion has a surface used for locating a panel, and the material of the panel is a recyclable material. The portable computer of the present invention allows a customer to select desired replaceable panels, and the discarded replaceable panels can be recycled and sorted as resource.

### CROSS-REFERENCE TO RELATED APPLICATION

This application claims the priority benefit of Taiwan application serial no. 95132313, filed Sep. 1, 2006. All disclosure of the Taiwan application is incorporated herein by reference.

### BACKGROUND OF THE INVENTION

1. Field of the Invention

The present invention generally relates to a portable electronic device, and more particularly, to a portable computer.

2. Description of Related Art

Along with the increasing popularity of computers day by day, governments of many countries follow the lead of the European Union (EU) Environmental Protection Mark and the Germany's Blue Angel Mark to set new environmental protection regulations and to standardize environmental protection plans on portable or desktop computers departing from factories, so as to encourage computer manufacturers to produce low-power consuming computer components and recyclable computer cases and display panels with low pollution.

Driven by the environmental protection awareness today, a strict standard in compliance with the EU's Restriction of Hazardous Substances Directive (RoHS directive) regarding all the utilized goods and the premier/paint of the electronic products including the portable computer has been set forth. The RoHS directive is an instruction regarding restricting the electronic and electrical equipments from utilizing harmful substances. The RoHS directive restricts the products from utilizing six harmful substances which are lead, mercury, cadmium, chromium VI (also known as hexavalent chromium or C6+), polybrominated biphenyl (PBB) and polybrominated diphenyl ether (PBDE). Although after an electronic product is discarded, the professional environmental protection institution is responsible for dealing with the subsequent recycling and sorting issues, only large-scale enterprises, schools or government departments follow the regulation to execute the recycling procedure. In fact, the public seldom follows the related regulation to send the discarded electronic products to the recycling management institution, which makes a great number of discarded electronic products not recycled and causes a lower recycle rate.

In particular, the case of conventional portable computer is made of plastic, and the plastic case is plated with a metal film thereon to meet the related electrical testing specification. Such a process makes the plastic case not recyclable and results in the resource waste and environment pollution. Therefore, how to solve the problem of recycling and reusing the material of the case has become an important environmental protection topic we are unable to ignore.

### SUMMARY OF THE INVENTION

Accordingly, the present invention is to provide a portable computer, which has a case with several detachable panels so recycling and sorting the case and panels becomes more convenient.

The present invention provides a plurality of electronic components and a case. The case includes a body shell portion, capable of accommodating the electronic components. The body shell portion has a surface suitable for locating a panel and the panel is made of a recyclable material.

According to the embodiment of the present invention, the body shell portion is distinguished into a plurality of units. The electronic components include a main board, a display and a keyboard which are respectively located in the corresponding units. The panel includes a group consisting of a main board base, a display back plate, a display frame and a keyboard panel.

According to the embodiment of the present invention, the panel is a replaceable panels. The material of the replaceable panels include at least a recyclable material selected from plastic, paper, bamboo, cloth and canvas.

According to the embodiment of the present invention, each of the units respectively has a fixing device, by which the replaceable panel is disposed on the surface of the corresponding unit. The fixing device includes a screw, a latch tenon or a latch slot.

According to the embodiment of the present invention, the case further includes a jointing portion, which is pivoted between the independent units. The jointing portion includes a hinge shaft, for example, while the independent units can be folded by swinging around the hinge shaft.

According to the embodiment of the present invention, the material of the above-mentioned body shell portion includes metal.

According to the embodiment of the present invention, the portable computer further includes a light-emitting module disposed between the case and at least one of the replaceable panels. The light-emitting module includes a light source, the case accordingly has a recess for accommodating the light source, and the replaceable panel for covering the light source has a transparent surface so as to allow the light of the light source to pass through. Also, there is a light-transparent pattern formed on the transparent surface that the light passes through.

The portable computer of the present invention adopts a structure suitable for separating the replaceable panels from the case thereof, therefore, the present invention allows the consumer to select the preferred replaceable panels, and the unused replaceable panels can be recycled and sorted.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic exploded view of a portable computer according to an embodiment of the present invention.

FIG. 2 is a schematic drawing showing the view of the portable computer in FIG. 1 assembled with replaceable panels.

FIG. 3 is a schematic view of a portable computer according to another embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

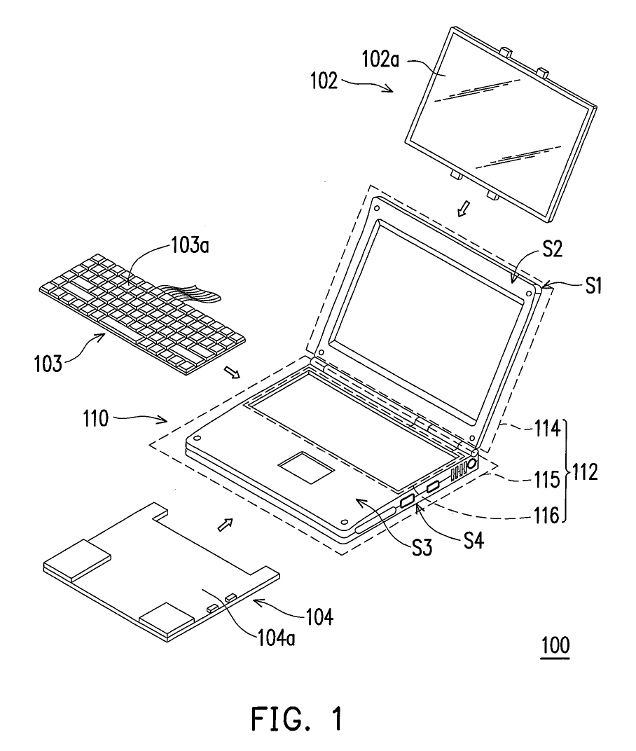

Referring to FIG. 1, FIG. 1 is a schematic exploded view of a portable computer according to an embodiment of the present invention. A portable computer 100 includes a plurality of electronic components 102-104 and a case 110. The case 110 has a body shell portion 112 suitable for accommodating all the electronic components 102-104 and served for assembling the electronic components in the case 110. According to the required functions, the body shell portion 112 is distinguished into a plurality of units 114-116, and the units 114-116 can respectively accommodate the electronic components 102-104 with different functions. For example, the first unit 114 is for assembling the electronic component 102 related with the display 102a, the second unit 115 is for assembling the electronic component 103 related with the main board 103a and the third unit 116 is for assembling the electronic component 104 related with the keyboard 104a. Note that although FIG. 1 in the present embodiment illustrates the body shell portion 112 having three units 114-116 only, but the present invention does not limit the unit quantity to three. Anyone skilled in the art should be able to integrate two units into a unit in accordance with the spirit of the present invention; for example, the units 114 and 116 for respectively including the display and the keyboard can be integrated into a touch-screen type display unit, or the units 114 and 115 for respectively including the display and the main board can be integrated into a tablet computer unit.

The preferred material of the body shell portion 112 is metal, for example, a tinned iron sheet (popularly termed as a electrolytic tinplate) or a zincified iron sheet. Alternatively, the body shell portion 112 may be made of original metal material or alloy material such as aluminum or stainless material, which is not applied any kind of chemical process as same as electroplating process. Since the body shell portion 112 made of metal has a shielding effect capable of preventing the leak and interference of electromagnetic waves and an advantageous electrical behaviors for conducting the current to be grounded, the body shell portion 112 is suitable for completely enclosing the electronic components 102-104 therein to get a protection. In addition, the metallic body shell portion 112 having sufficient stiffness and sustaining power is unlikely to be deformed and easy to be processed. Furthermore, it possesses a higher coefficient of thermal conductance (CTC) to quickly conduct the waste heat produced inside the electronic components 102-104 outwards.

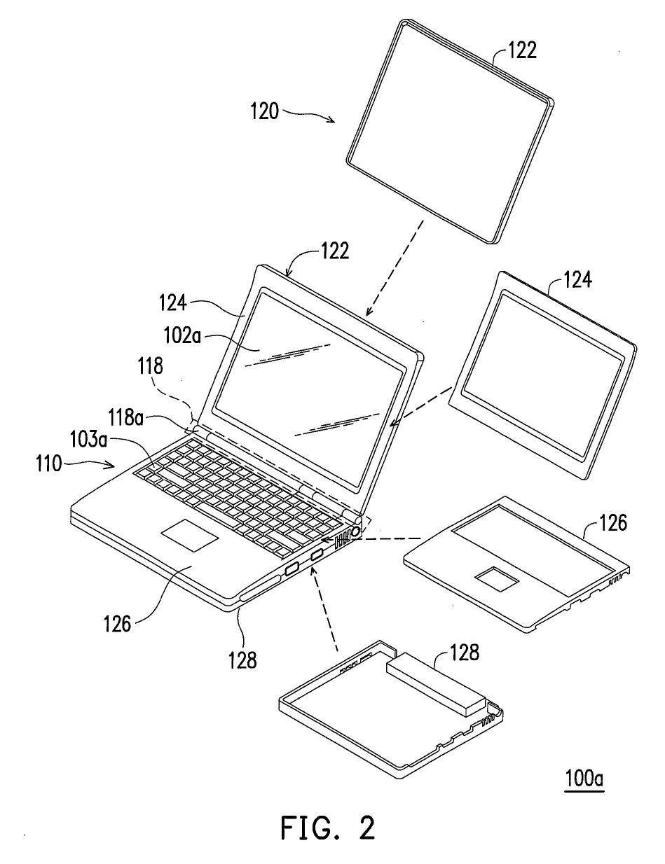

After the electronic components 102-104 of the above-mentioned portable computer 100 are assembled in the case and electrically connected to each other, the portable computer 100 is ready to execute the needed operations through a processor on the main board 103a or other control chips (not shown), such as implementing an application, network data transmissions or peripheral interface operations, whose details are omitted to describe for simplicity. Different from the conventional computer, the panels on the different surfaces of the units 114-116 are replaceable (as shown by FIG. 2) and the panels are mainly made of recyclable material, therefore the computer of the present invention is in compliance with the environmental protection requirement.

Referring to FIG. 2, FIG. 2 is a schematic drawing showing the view of the portable computer in FIG. 1 equipped with the replaceable panels. The replaceable panels 120 are fabricated according to the corresponding shapes and structures of all the units 114-116 and independently assembled on the case 110 of FIG. 1. In the embodiment, the replaceable panels 120 mainly include four shells, for example, a display back plate. 122, a display frame 124, a keyboard panel 126 and a main board base 128. The shells are made of recyclable materials without plating or other high-pollution processing, thus the present invention is able to make the resource-recycling program feasible. In comparison with a conventional computer where the conventional plastic case is plated directly with metal film and is not recyclable, the case 110 and the replaceable panels 120 of the present invention are independently separated and detachable from one another for recycling, which provides a great convenience for recycling and sorting the resource. In particular, any recyclable and environmental-friendly material can be used to fabricate the replaceable panel 120; for example, the material such as plastic, paper, bamboo, cloth, canvas or man-made leather with appropriate processing can be used to fabricate the replaceable panel 120 with different shapes. In particular, the material mentioned above can be applied artistic colors such as oil painting, which would not damage environment, to make the product please. To deserve to be mentioned, the panel used in the present invention can be a panel without electroplating process.

As a customer purchases a portable computer 100, different replaceable panels 120 can be selected by the customer for being assembled on the case 110. For example, a customer can select a plastic panel coloured with patterns, a simple and plain paper or bamboo panel, or an elegant cloth or leather panel according to the desired personalized style.

The case 110 of the portable computer 100a in FIG. 2 further includes a jointing portion 118, which is pivoted between the independent two units 114 and 115, so as to make the two units 114 and 115 move or swing relatively to one another thereby. In more detail, the jointing portion 118 can include a hinge shaft 118a, while the independent two units 114 and 115 can be folded by swinging around the hinge shaft 118a, which provides a great convenience to open or close them.

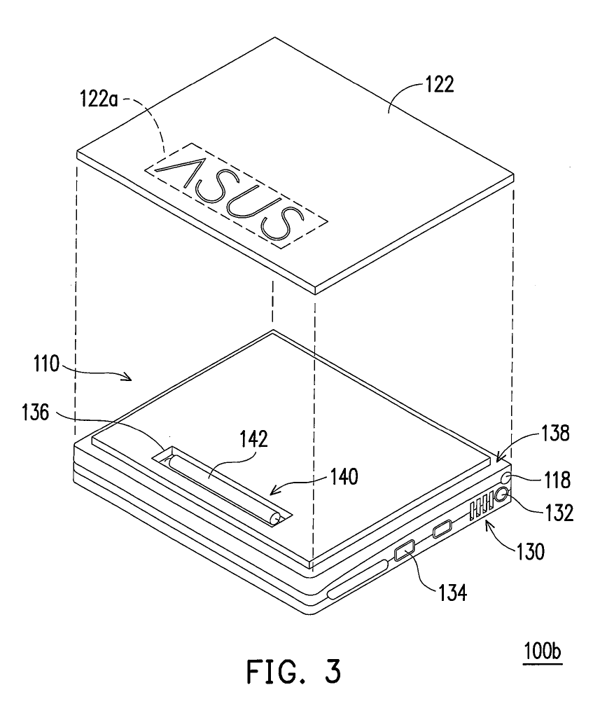

Referring to FIG. 3, FIG. 3 is a schematic view of a portable computer according to another embodiment of the present invention. A portable computer 100b further includes a power jack 132 and at least a connection port 134, and the waste heat produced by the electronic components inside the case 110 can be expelled through a heat-dissipating opening 130. The power jack 132 is disposed, for example, on a side of the case 110 and connected to an external power supply; and the connection port 134 is disposed, for example, on the side of the case 110 for the peripheral electronic devices of the computer (for example, the keyboard or the mouse) to be electrically connected to the processor (not shown) inside the case.

In addition, the portable computer 100b further includes a light-emitting module 140, which is disposed between the case 110 and the display back plate 122. The case 110 has, for example, a recess 136 for accommodating a light source 142 of the light-emitting module 140. When the display back plate 122 is folded to cover the case 110, the light emitted from the light source 142 can pass through the transparent surface 122a of the display back plate 122. For example, a pattern with a product trademark or a name (ASUS, for example) is made on the transparent surface 122a of the display back plate 122 and the pattern is illuminated by the light emitted from the light source 142 to highlight the style of the product. The light-emitting module 140 is not limited to FIG. 3, and anyone skilled in the art is able to dispose the light-emitting module 140 under other replaceable panels 124, 126 or 128 referring to the present embodiment.

In FIG. 3, when the display back plate 122 covers the surface of the case 110, the edges of the display back plate 122 can be fixed on the surface of the case by a latch slot 138 located surrounding the case 110; but the embodiment does not limit the present invention thereto and anyone skilled in the art can adopt a fixing device such as screws or a latch tenon for fixing the display back plate 122. Similarly, other replaceable panels 124, 126 and 128 can be respectively disposed on the different surfaces of the case 110 by different types of fixing devices (not shown) as well, which are omitted to describe herein for simplicity.

In summary, the portable computer of the present invention has the following advantages:

(1) By using the case to fix all the electronic components therein and making each of the units have a surface used for locating the corresponding panel, the portable computer of the present invention enables a customer to select desired replaceable panels for creating a personalized style with the purchased product.

(2) The invention of making the case and the replaceable panels independently detachable from each other provides a great convenience to recycle and sort the resource.

(3) Any recyclable material can be used to fabricate the replaceable panels without requiring plating or other high-pollution processing, thus the present invention is able to make the resource-recycling program feasible.

(4) The body shell portion made of metal has excellent shielding effect, high sustaining strength, and is unlikely to be deformed. In addition, the body shell portion is easy to be processed and is able to quickly dissipate heat.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A portable computer, comprising:
a plurality of electronic components; and
a case, comprising a body shell portion suitable for accommodating the electronic components, wherein the body shell portion has a surface used for locating a panel, wherein the panel is made of a recyclable material.

2. The portable computer according to claim 1, wherein the body shell portion is distinguished into a plurality of units and each of the units respectively has the surface used for locating the panel.

3. The portable computer according to claim 2, wherein the electronic components comprise a main board, a display and a keyboard respectively located in the units.

4. The portable computer according to claim 1, wherein the panel is a replaceable panel.

5. The portable computer according to claim 4, wherein the replaceable panels is made of at least a recyclable material selected from plastic, paper, bamboo cloth and canvas.

6. The portable computer according to claim 4, wherein each of the units respectively has a fixing device, and each of the replaceable panels is respectively disposed on the surface of each of the units by the fixing device.

7. The portable computer according to claim 6, wherein the fixing device comprises a screw, a latch tenon or a latch slot.

8. The portable computer according to claim 2, wherein the case further comprises a jointing portion pivoted between the units.

9. The portable computer according to claim 8, wherein the jointing portion comprises a hinge shaft, and the units can be folded by swinging around the hinge shaft.

10. The portable computer according to claim 1, wherein the body shell portion is made of metal.

11. The portable computer according to claim 4, further comprising a light-emitting module disposed between the case and the replaceable panel.

12. The portable computer according to claim 11, wherein the light-emitting module comprises a light source, the case has a corresponding recess for accommodating the light source and the replaceable panel for covering the light source has a transparent surface to allow the light of the light source to pass through the transparent surface.

13. The portable computer according to claim 12, wherein a light-transparent pattern is formed on the transparent surface.

14. The portable computer according to claim 2, wherein the panel comprises a group consisting of a main board base, a display back plate, a display frame and a keyboard panel.
